(19) United States
(12) Patent Application Publication
(10) Pub. No.: US 2002/0186564 A1
(43) Pub. Date: Dec. 12, 2002

(54) Light adjusting and controlling assembly

(76) Inventor: Tung-Liang Li, Tainan (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 09/877,356

(22) Filed: Jun. 8, 2001

(51) Int. Cl. F21V 1/00

(52) U.S. Cl. 362/276; 362/295; 362/394

(57) ABSTRACT

A light adjusting and controlling assembly has a light adjusting module, an illumination sensor, and a controller. The light adjusting module is connected to the illumination sensor. The illumination sensor is connected to the controller.

### BACKGROUND OF THE INVENTION

The present invention relates to a light adjusting and controlling assembly. More particularly, the present invention relates to a light adjusting and controlling assembly which is operated automatically.

A conventional light adjusting and controlling device is often operated manually.

### SUMMARY OF THE INVENTION

An object of the present invention is to provide a light adjusting and controlling assembly which is operated automatically.

### BRIEF DESCRIPTION OF THE DRAWINGS

FIG. 1 is a perspective exploded view of a lamp and a light adjusting and controlling assembly of a preferred embodiment in accordance with the present invention; and

FIG. 2 is a perspective exploded view of a control panel and a light adjusting and controlling assembly of a preferred embodiment in accordance with the present invention.

### DETAILED DESCRIPTION OF THE INVENTION

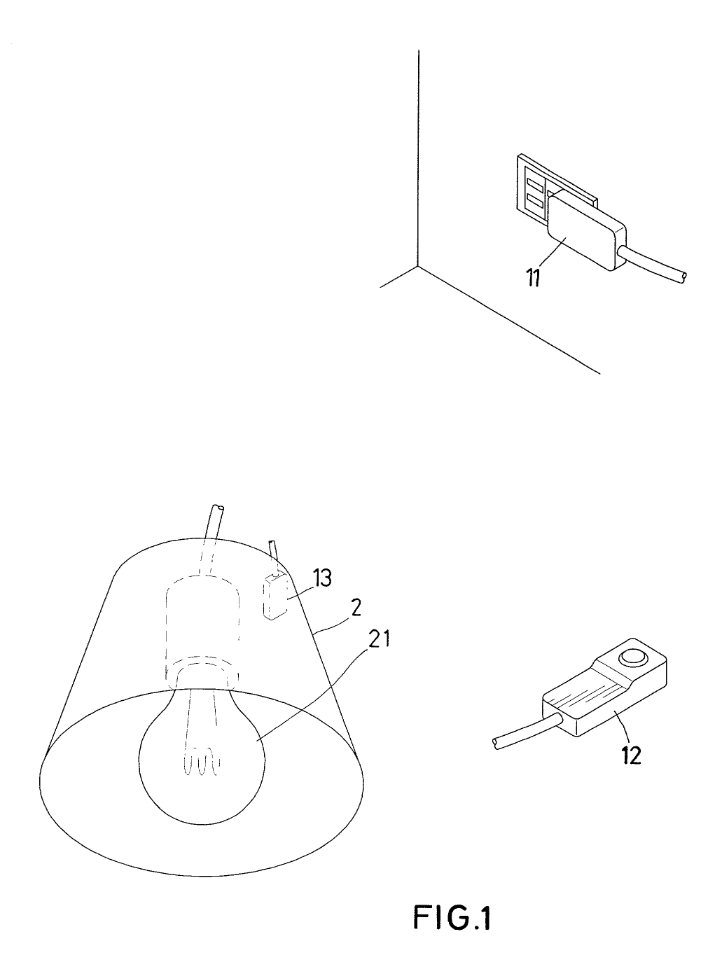

Referring to FIG. 1, a first light adjusting and controlling assembly comprises a light adjusting module 11, an illumination sensor 12, and a controller 13.

The light adjusting module 11 is connected to the illumination sensor 12.

The illumination sensor 12 is connected to the controller 13.

The controller 13 is disposed in a lamp 2. The lamp 2 has a bulb 21.

The illumination sensor 12 sends a signal to the light adjusting module 11.

The light adjusting module 11 sends an output signal to the controller 13.

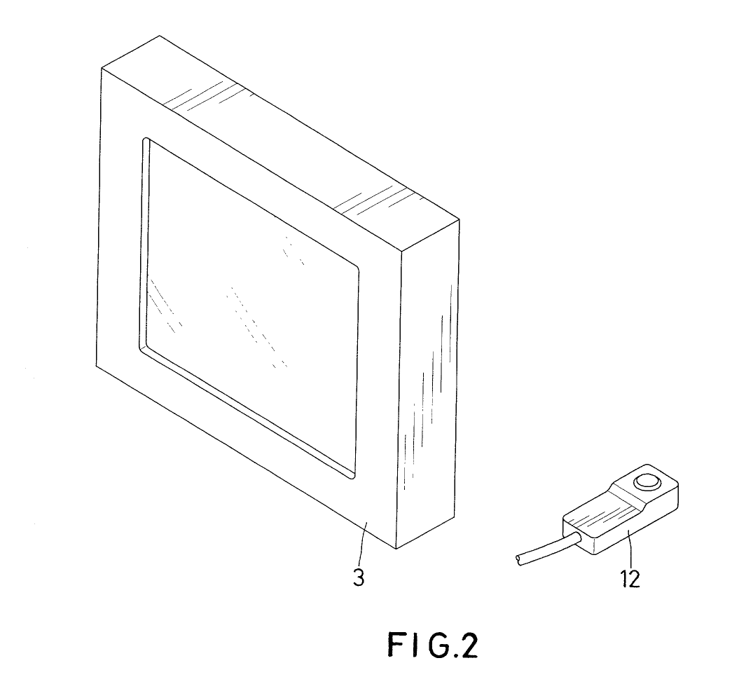

Referring to FIG. 2, the controller 13 is disposed in a control panel 3,

The present invention is not limited to the above embodiment but various modification thereof may be made. Furthermore, various changes in form and detail may be made without departing from the scope of the present invention.

I claim:

1. A light adjusting and controlling assembly comprises:
a light adjusting module, an illumination sensor, and a controller,
the light adjusting module connected to the illumination sensor, and
the illumination sensor is connected to the controller.

2. The light adjusting and controlling assembly as claimed in claim 1, wherein the controller is disposed in a lamp.

3. The light adjusting and controlling assembly as claimed in claim 1, wherein the controller is disposed in a control panel.
